(19) United States
(12) Patent Application Publication
(10) Pub. No.: US 2014/0198005 A1
(43) Pub. Date: Jul. 17, 2014

(54) LOW PROFILE ANTENNA

(71) Applicant: CMC ELECTRONIQUE INC. / CMC ELECTRONICS INC., Montreal (CA)

(72) Inventors: Alan Julian Paul HNATIW, Stittsville (CA); John Patten CARR, Kanata (CA); Matthew Philip HILLS, Kanata (CA)

(73) Assignee: CMC ELECTRONIQUE INC. / CMC ELECTRONICS INC., Montreal (CA)

(21) Appl. No.: 13/743,132

(22) Filed: Jan. 16, 2013

(51) Int. Cl. H01Q 13/02; H01P 11/00

(52) U.S. Cl. CPC H01Q 13/0233; H01P 11/001
USPC 343/776; 29/600

(57) ABSTRACT

There is provided a low profile antenna comprising a line source, a corporate feed network, and a plurality of radiating elements. The radiating elements are arranged in a linear array so as to be discrete in a first direction and each continuous in a second direction substantially perpendicular to the first direction. The corporate feed network is integrated with the linear array of radiating elements to provide for a compact design.

### CROSS-REFERENCE TO RELATED APPLICATIONS

This is the first application filed for the present invention.

### TECHNICAL FIELD

The present invention relates to the field of antennas, and more particularly low profile antennas.

### BACKGROUND OF THE ART

A combination of a waveguide feed network and radiator element may be used to enable an antenna to collect energy from a large area and guide the collected energy to a single input/output waveguide, which may in turn be connected to a transmitter/receiver. In order to economically transmit electromagnetic energy from an antenna aperture, both an efficient radiating aperture and feed network are typically required.

For narrow-band, i.e. 5% bandwidth, applications, slot radiators are often used to fill the antenna aperture. However, due to the periodicity of a wavelength of the transmitted or received signal, the slots need to be spaced no more than one guide wavelength apart in the vertical and horizontal direction. This architecture thus requires N horizontal radiators and M vertical radiators, for a total of N×M radiators. The resulting complexity in creating the feed network and fabricating the multitude of slots is then costly and leads to poor performance. For example, limited bandwidth, frequency scanning, and the like may result. This problem can also be found in other conventional antenna designs using different radiators, such as patches, printed dipoles, etc., as the latter usually still require N×M radiators.

There is therefore a need for an improved low profile antenna.

### SUMMARY

In accordance with a first broad aspect, there is provided a low profile antenna comprising a radiator array comprising a plurality of radiating elements arranged linearly along a first direction, each one of the plurality of radiating elements adapted to radiate along a second direction substantially perpendicular to the first direction, and a corporate feed network integrated with the radiator array, the corporate feed network comprising an input transmission line adapted to receive an input signal and a plurality of output transmission lines each coupled to the input transmission line and to a corresponding one of the plurality of radiating elements, the input signal adapted to be routed among the plurality of output transmission lines for delivery to the plurality of radiating elements.

In accordance with a second broad aspect, there is provided a method for manufacturing a low profile antenna, the method comprising arranging a plurality of radiating elements linearly along a first direction to form a radiator array, each one of the plurality of radiating elements adapted to radiate along a second direction substantially perpendicular to the first direction, and integrating a corporate feed network with the radiator array, the corporate feed network comprising an input transmission line adapted to receive an input signal and a plurality of output transmission lines each coupled to the input transmission line and to a corresponding one of the plurality of radiating elements, the input signal adapted to be routed among the plurality of output transmission lines for delivery to the plurality of radiating elements.

### BRIEF DESCRIPTION OF THE DRAWINGS

Further features and advantages of the present invention will become apparent from the following detailed description, taken in combination with the appended drawings, in which:

FIG. 1 is a front perspective view of an antenna aperture in accordance with an illustrative embodiment of the present invention;

FIG. 2a is a cross-sectional view of the antenna aperture of FIG. 1;

FIG. 2b is a right side view of the corporate feed network of FIG. 2a;

FIG. 3a is a perspective view of a folded reflective line source for use in the antenna of FIG. 1;

FIG. 3b is a perspective view of a discretized line source for use in the antenna of FIG. 1;

FIG. 4 is a perspective view of the antenna aperture of FIG. 1 mounted on an elevation over azimuth computer controlled positioner;

FIG. 5a is a plot of a simulated azimuth gain pattern for the antenna of FIG. 1; and

FIG. 5b is a plot of a simulated elevation gain pattern for the antenna of FIG. 1.

It will be noted that throughout the appended drawings, like features are identified by like reference numerals.

### DETAILED DESCRIPTION

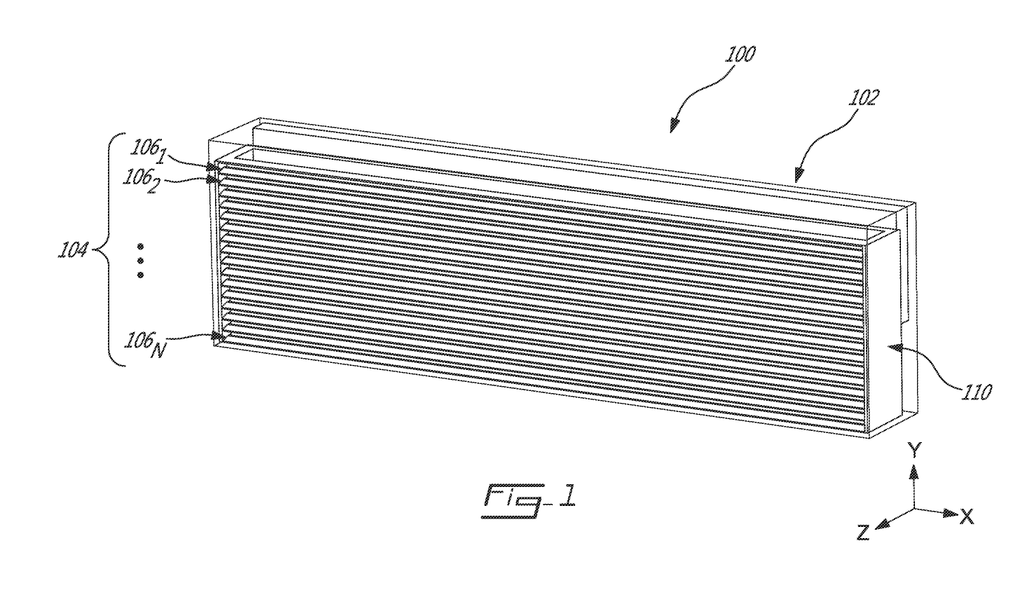

Referring now to FIG. 1, an antenna aperture 100 having a low profile will now be described. The antenna aperture 100 illustratively comprises a line source 102 and a linear radiator array 104 comprising a number N of horizontal radiators 106₁, . . . , 106_{N} each extending along the X axis and a number M of vertical radiators (not shown) each extending along the Y axis. It should be understood that the number of radiators as in 106₁, . . . , 106_{N} in the array 104 may vary according to system requirements. Each radiator as in 106₁, . . . , or 106_{N} may be a tapered slot antenna that is adapted to radiate at a given directionality the energy of an electromagnetic wave received thereat. It should be understood that other configurations of the radiator may apply.

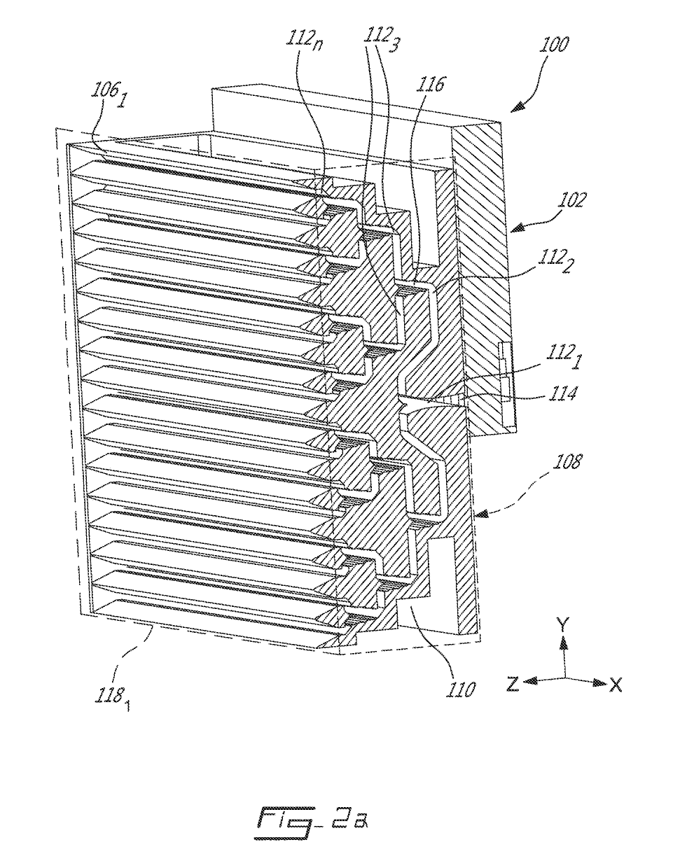

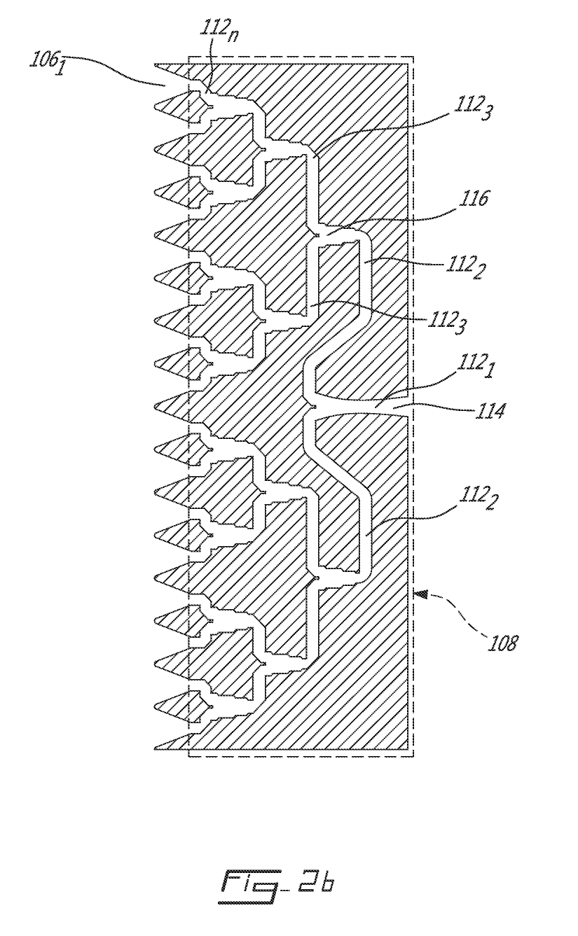

Referring to FIG. 2a and FIG. 2b in addition to FIG. 1, the antenna aperture 100 further comprises a corporate feed network 108 supplying electromagnetic energy to the radiators 106₁, . . . , 106_{N}. In one embodiment, the radiators 106₁, . . . , 106_{N} are integrated with the feed network 108 as a single component. For this purpose, both the radiators 106₁, . . . , 106_{N} and the feed network 108 may be manufactured from the same waveguide piece 110 having an air-filled or other appropriate structure, such as a dielectric-filled or partially-filled waveguide structure. For example, each radiator as in 106₁, . . . , or 106_{N} may be etched on the waveguide piece 110 and excited using the corporate feed network 108 also etched on the waveguide piece 110. High speed machining, extrusion, casting, molding, e.g. injection molding, or any other suitable manufacturing process known to those skilled in the art may also be used. The radiator array 104 may for instance be manufactured using solid metal extrusions, hollow extrusions, plastic extrusions, or composite extrusions with application of a metal coating or foil. The line source 102 may then be provided separately from the integrated radiators 106₁, . . . , 106_{N} and feed network 108. In particular, when in use, the line source 102 may be coupled to feed network 108 to become part thereof. In this manner, a low weight and compact size antenna aperture 100 may be provided.

The line source 102 may further be coupled to a source of electromagnetic signals (not shown), from which an input signal may be received. The line source 102 may then transform the input into an output having an expanded dimension, e.g. width, along the X axis. In one embodiment discussed further below, a single mode input is provided by the source to the line source 102 and the latter outputs a single linear beam that is continuous along the X axis. The signal output by the line source 102 may then be transmitted to the feed network 108 and replicated thereby to feed each one of the N horizontal radiators 106₁, . . . , 106_{N} for transmittal. Although the antenna aperture 100 is described herein in the context where it is used as a transmitter, it should be understood that the antenna aperture 100 may, by reciprocity, be used as a receiver and route receive signals to single outputs.

The feed network 108 may comprise a plurality of transmission or feed lines as in 112₁, . . . , 112ₙ and power dividers (not shown) provided over a number n of successive feed levels. The first feed level, i.e. level 1, is illustratively the level closest to the line source 102 while the last feed level, i.e. level n, is the level closest to the radiator array 104. Each one of the transmission lines provided at the last feed level n, e.g. transmission line 112ₙ in FIG. 2a and FIG. 2b, may then be coupled to a corresponding radiator, e.g. radiator 106₁, of the radiator array 104. In this manner, the output of each one of the transmission lines found at the last feed level may be provided to the corresponding radiator as in 106₁, . . . , or 106_{N} for feeding thereof. In particular, the feed network 108 illustratively receives at an input port 114 thereof the expanded signal output by the line source 102. The feed network 108 may then split the energy of the received signal among the transmission lines 112₁, . . . , 112ₙ of the multiple feed levels. This may be achieved using power dividers that implement binary power splits, i.e. power splits of 2ⁿ⁻¹, with n=1, 2, 3, 4 . . . being the number of feed levels of the corporate feed architecture. As known to those skilled in the art, the power splits may be accomplished by using tapered lines or impedance transformers. It should also be understood that, instead of binary power splits, the feed network 108 may achieve triple or quadruple power splits. Still, binary power splits may be preferable as they gave a simple design.

For this purpose, each one of the transmission lines 112₁, . . . , 112ₙ₋₁ is split into two (2) transmission lines provided at the next feed level. For instance, a transmission line at a level n, e.g. transmission line 112₂ at the second feed level, is illustratively terminated by a junction 116, which branches out into a first and a second transmission line provided at the following level n+1, e.g. transmission lines 112₃ at the third feed level. It should be understood that depending on the type of power splits accomplished, each transmission line at a given level may be split into more than two (2) transmission lines at the next level. The junction 116 may be a tee junction where the first and second transmission lines, e.g. transmission lines 112₃, meet at an angle of substantially ninety (90) degrees and are collinear to one another. It should be understood that, although other configurations, e.g. y-junction geometries, may apply, the tee junction geometry may be preferable as it ensures a low profile for the feed network 108. Also, the energy of the signal routed through the transmission line of level n, e.g. transmission line 112₂, is illustratively divided at the junction 116 among the first and second transmission lines of level n+1, e.g. transmission lines 112₃.

Although even power distribution may be desirable, the power split provided at each junction 116 of the feed network 108 may be an equal or unequal power split. Thus, the amplitudes of the signals provided at the first and the second transmission lines of level n+1 may be equal or unequal. As will be discussed further below, non-uniform power distribution may be used to lower sidelobe levels of the gain pattern of the antenna aperture 100. The phases of the signals provided at the first and the second transmission lines of level n+1 may also be uniform or non-uniform, e.g. equal or unequal. For instance, non-uniform phases may be used when it is desired to squint a beam or otherwise shape the far-field gain pattern of the antenna aperture 100. In FIG. 2a and FIG. 2b, the feed network 108 feeds N=16 radiators 106₁, . . . , 106_{N} using equal binary power splits and uniform phase over n=5 levels.

In one embodiment, the combination of the line source 102 and the feed network 108 may be used to feed N horizontal radiators 106₁, . . . , 106_{N} and M=1 vertical radiators (not shown), i.e. a single vertical radiator as in 118₁. As such, the linear radiator array 104 illustratively comprises N horizontal radiators 106₁, . . . , 106_{N} arranged in a single column along the Y axis so that the radiator array 104 comprises a radiator arrangement, which is discrete along the vertical Y axis and continuous along the horizontal X axis. The line source 102 may then provide the horizontal excitation to the radiator array 104 while the corporate feed network 108 provides the vertical excitation.

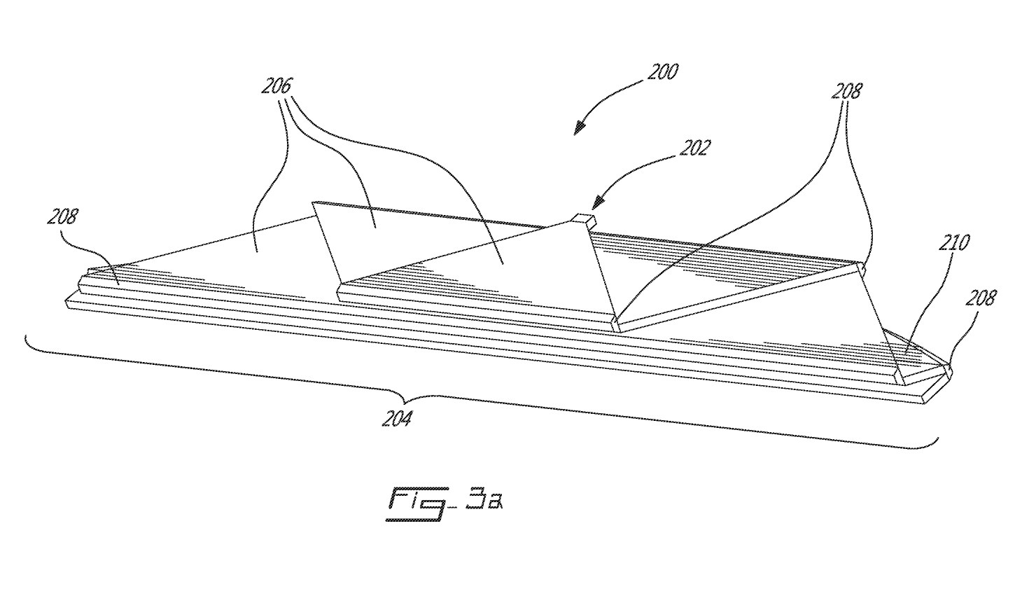

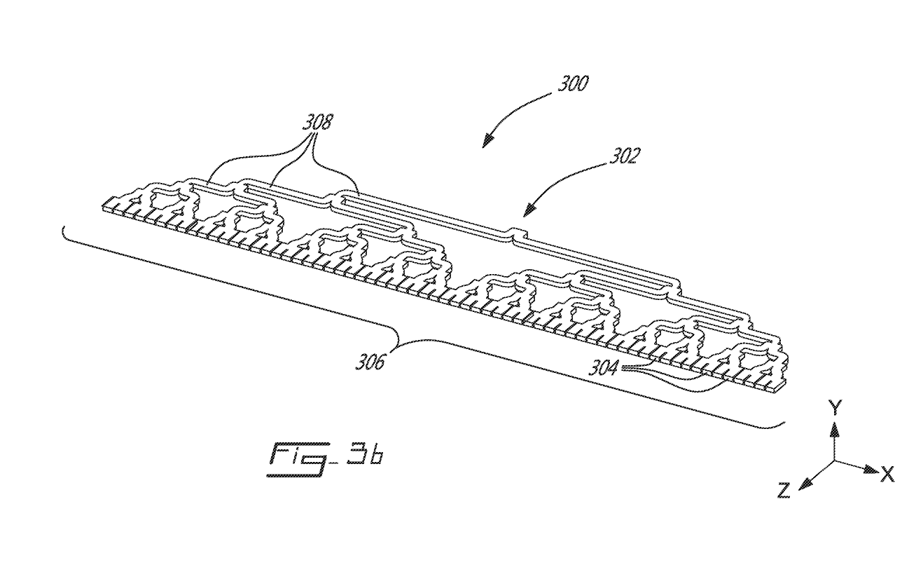

Referring to FIG. 3a and FIG. 3b in addition to FIG. 1, although the embodiment of FIG. 1 illustrates a radiator array 104 where each horizontal radiator as in 106₁, . . . , 106_{N} is continuous along the X axis, it should be understood that each horizontal radiator as in 106₁, . . . , 106_{N} may also be discretized along the X axis. In particular, to arrive at the embodiment of FIG. 1, the line source 102 may comprise a folded reflective line source architecture 200, as shown in FIG. 3a. Still, it should be understood that other configurations may apply. The folded reflective line source 200 may be used to transform a single mode input 202 into a single line source 204 that is continuous along the X axis, i.e. the horizontal direction. The line source 204 illustratively has a dimension along the X axis, e.g. a width, that is expanded compared to the dimension of the single mode input 202 along the same X axis.

For this purpose, the folded reflective line source 200 may comprise a plurality of taper regions as in 206 adapted to expand a beam propagating therethrough. The taper regions 206 may be provided in a stacked relationship and connected by 180 degree reflectors as in 208. Each reflector 208 may be used to fold the direction of propagation of a beam traveling down each one of the taper regions 206, thereby ensuring compactness of the structure. The folded reflective line source 200 may also comprise a reflective phase compensator 210 for compensating for the phase error introduced during travel of the beam down the successive taper regions 206. Using such a folded reflective line source 200 to build the antenna aperture 100 may result in a circuit largely comprised of slab waveguides. Such a slab waveguide geometry illustratively has low loss and allows most of the antenna design to be constructed from low cost extrusions. For example, aluminum metal extrusions or metal coated plastic extrusions or molded parts may be used.

Alternatively and as shown in FIG. 3b, the line source 102 may comprise a corporate feed line source architecture 300, which produces an output that is discretized along the X axis. The energy radiated by each one of the horizontal radiators as in 106₁, . . . , 106_{N} may in turn be discretized. In particular, the corporate feed line source 300 may be used to transform a single mode input 302 into a plurality of discrete outputs 304 distributed along the direction of the X axis. The discrete outputs 304 may together form a discretized output 306 having an overall dimension along the X axis, e.g. a width, that is expanded compared to the dimension of the single mode input 302 along the same X axis. For this purpose, the corporate feed line source 300 may comprise multiple feed lines as in 308 providing binary power splits over a plurality of levels (not shown). In the embodiment of FIG. 3b, the corporate feed line source 300 transforms the single mode input 302 into sixty-four (64) discretized outputs 304 over seven (7) levels.

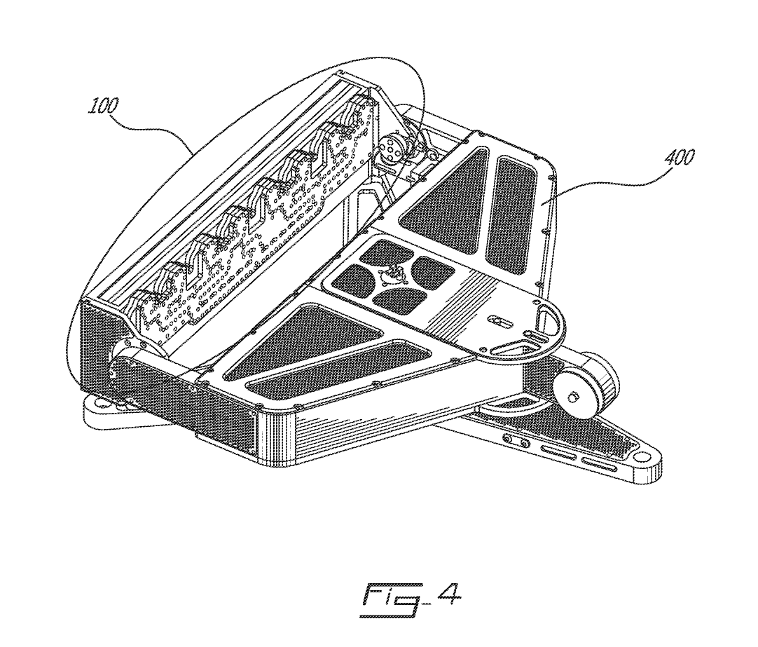

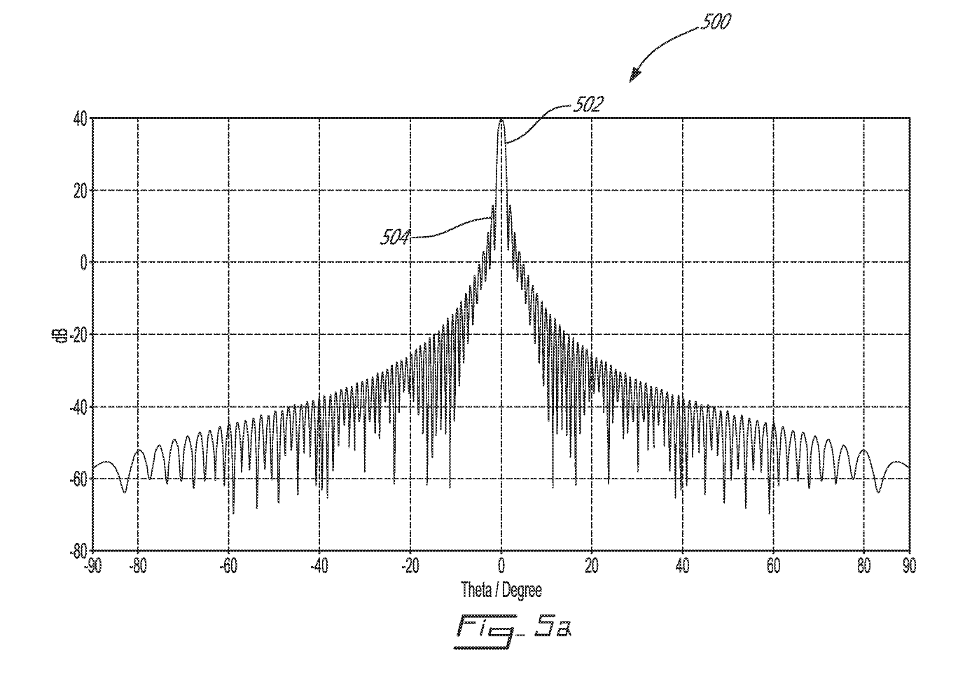

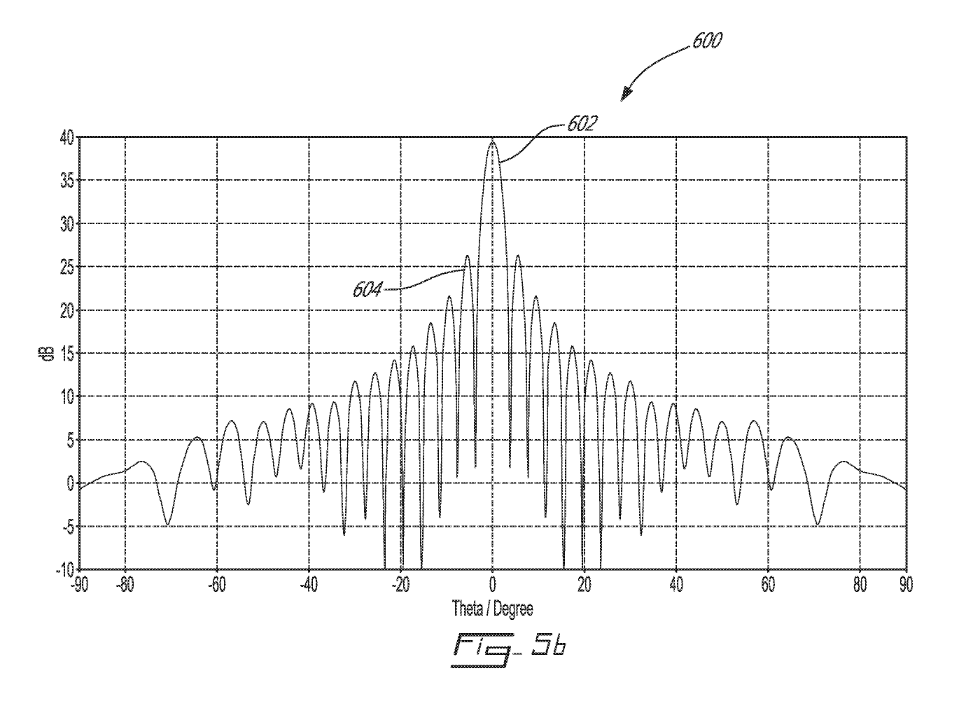

Referring now to FIG. 4 in addition to FIG. 1, the antenna aperture 100 may be incorporated into a computer-controlled elevation over azimuth rotary antenna positioner 400. As known to those skilled in the art, such an antenna positioner 400 may be used to position the antenna 100 for tracking a moving object (not shown). In the embodiment of FIG. 4, an antenna aperture having a dimension along the X axis, i.e. a length, of 594.06 mm, a dimension along the Y axis, i.e. a height of 152.50 mm, and a dimension along the Z axis, i.e. a width of 56.31 mm is used. Elevation and azimuth gain patterns may then be measured, as shown in FIG. 5a and FIG. 5b.

FIG. 5a shows a simulated azimuth gain pattern 500 at a frequency of 30 GHz for the antenna aperture 100 of FIG. 4. It can be seen that the first sidelobe 502 in the azimuth gain pattern 500 is approximately 23 dB below the peak 504, as desired in aeronautical applications and the like. Indeed, it is desirable, when communicating with a geostationary satellite, for the azimuth pattern as in 500 to provide low side lobe levels in order to comply with regulatory requirements to limit interference with adjacent satellites.

FIG. 5b shows a simulated elevation gain pattern 600 at a frequency of 30 GHz for the antenna aperture 100 of FIG. 4. As discussed above, since the elevation feed shown in FIG. 5b illustratively uses equal output binary power splitters (not shown) for splitting the power of the signal received from the line source 102, a uniform excitation may be achieved along the Y axis, i.e. the vertical direction, of the radiator array 104. This results in higher sidelobes being obtained for the elevation gain pattern 600 than for the azimuth gain pattern 500. In particular, the uniform excitation leads to the first sidelobe 604 being at approximately 13 dB below the peak 602. As discussed above with reference to FIG. 2a and FIG. 2b, it should be understood that feed designs using unequal splits may be used in some applications. In this case, one could achieve an antenna aperture where each radiator of the radiator array 104 provides a non uniform illumination, e.g. more energy is output towards the center of the radiator than at the edges thereof. The gain pattern of such an antenna aperture would thus comprise a wider main beam and lower sidelobe levels. However, this would lower the gain of the overall antenna structure. As gain is the principal limiting factor for aeronautical satellite communications antennas, sidelobe control in the elevation plane is of limited utility. The reduction in antenna gain would therefore not provide any additional net benefit for the intended applications.

Referring back to FIG. 1, the antenna aperture 100 illustratively has low loss and high gain over a large frequency bandwidth. In particular, broadband response over 50% of the bandwidth may be achieved and the design may be scalable from 5 GHz to 75 GHz operating frequency. This is particularly desirable for satellite communications applications where a wideband signal is to be radiated in a single direction regardless of the input frequency. The antenna aperture 100 may further allow for a minimal number of radiator elements to be used in the radiator array 104, thus achieving a low profile and low weight structure having a flat plate, i.e. compact, design. The impact of an installed system on the operating costs of a device, such as an aircraft, may therefore minimized while achieving high performance.

The embodiments of the invention described above are intended to be exemplary only. The scope of the invention is therefore intended to be limited solely by the scope of the appended claims.

1. A low profile antenna comprising:
a radiator array comprising a plurality of radiating elements arranged linearly along a first direction, each one of the plurality of radiating elements adapted to radiate along a second direction substantially perpendicular to the first direction; and
a corporate feed network integrated with the radiator array, the corporate feed network comprising an input transmission line adapted to receive an input signal and a plurality of output transmission lines each coupled to the input transmission line and to a corresponding one of the plurality of radiating elements, the input signal adapted to be routed among the plurality of output transmission lines for delivery to the plurality of radiating elements.

2. The antenna of claim 1, wherein the plurality of radiating elements of the radiator array are arranged in a single column along the first direction, the first direction being a vertical direction.

3. The antenna of claim 1, further comprising a line source adapted to be coupled to the corporate feed network for supplying the input signal to the input transmission line.

4. The antenna of claim 3, wherein the line source is a folded reflective line source adapted to receive a single mode input having a first width and to transform the single mode input into the input signal, wherein the input signal has a second width greater than the first width and is continuous along the second direction.

5. The antenna of claim 4, wherein the corporate feed network is adapted to route the input signal among the plurality of output transmission lines for delivery to the plurality of radiating elements, thereby causing each one of the plurality of radiating elements to radiate an output signal that is continuous along the second direction.

6. The antenna of claim 3, wherein the line source is a corporate feed line source adapted to receive thereat a single mode input having a first width and to transform the single mode input into the input signal, wherein the input signal comprises a plurality of discrete sources arranged along the second direction.

7. The antenna of claim 6, wherein the corporate feed network is adapted to route the input signal among the plurality of output transmission lines for delivery to the plurality of radiating elements, thereby causing each one of the plurality of radiating elements to radiate an output signal that is discretized along the second direction.

8. The antenna of claim 3, wherein the corporate feed network further comprises a plurality of intermediary transmission lines, the input line, the plurality of intermediary lines, and the plurality of output transmission lines distributed among a plurality of feed levels.

9. The antenna of claim 8, wherein the plurality of feed levels of the corporate feed network comprises a first feed level arranged adjacent the line source and a last feed level arranged adjacent the radiator array, the input transmission line provided at the first feed level and the plurality of output transmission lines provided at the last feed level.

10. The antenna of claim 8, wherein the corporate feed network comprises a plurality of junctions for arranging the plurality of intermediary lines and the plurality of output transmission lines in pairs over successive ones of the plurality of feed levels, each one of the plurality of junctions adapted to receive a first signal and to output a second and a third signal.

11. The antenna of claim 10, wherein the corporate feed network comprises a plurality of power dividers each provided at a corresponding one of the plurality of junctions for dividing a first power of the first signal into a second power of the second signal and a third power of the third signal, the second power equal to the third power.

12. The antenna of claim 10, wherein the corporate feed network comprises a plurality of power dividers each provided at a corresponding one of the plurality of junctions for dividing a first power of the first signal into a second power of the second signal and a third power of the third signal, the second power different from the third power.

13. The antenna of claim 10, wherein the corporate feed network comprises a plurality of power dividers each provided at a corresponding one of the plurality of junctions for dividing a first power of the first signal into a second power of the second signal and a third power of the third signal, the second signal having a phase equal to that of the third signal.

14. The antenna of claim 10, wherein the corporate feed network comprises a plurality of power dividers each provided at a corresponding one of the plurality of junctions for dividing a first power of the first signal into a second power of the second signal and a third power of the third signal, the second signal having a phase different from that of the third signal.

15. The antenna of claim 1, wherein the radiator array and the corporate feed network are manufactured from a same waveguide piece.

16. The antenna of claim 15, wherein the radiator array is manufactured using one of solid metal extrusions, hollow extrusions, plastic extrusions, composite extrusions, casting, and molding.

17. A method for manufacturing a low profile antenna, the method comprising:
arranging a plurality of radiating elements linearly along a first direction to form a radiator array, each one of the plurality of radiating elements adapted to radiate along a second direction substantially perpendicular to the first direction; and
integrating a corporate feed network with the radiator array, the corporate feed network comprising an input transmission line adapted to receive an input signal and a plurality of output transmission lines each coupled to the input transmission line and to a corresponding one of the plurality of radiating elements, the input signal adapted to be routed among the plurality of output transmission lines for delivery to the plurality of radiating elements.

18. The method of claim 17, wherein linearly arranging the plurality of radiating elements comprises arranging the plurality of radiating elements in a single column along the first direction, the first direction being a vertical direction.

19. The method of claim 17, further comprising coupling a line source to the corporate feed network for supplying the input signal to the input transmission line.
